(19) United States
(12) Patent Application Publication
(10) Pub. No.: US 2021/0118044 A1
(43) Pub. Date: Apr. 22, 2021

(54) CLOTHING DISTRIBUTION SYSTEM

(71) Applicant: DEZIGNEREX GROUP PTY LTD, PYRMONT (AU)

(72) Inventors: Costa KOULIS, PYRMONT (AU); Kirsten KORE, PYRMONT (AU)

(21) Appl. No.: 17/134,734

(22) Filed: Dec. 28, 2020

Related U.S. Application Data
(63) Continuation-in-part of application No. 15/513,111, filed on Mar. 21, 2017.

(30) Foreign Application Priority Data
Sep. 22, 2014 (AU) 2014903773
Feb. 27, 2015 (AU) 2015900702
Jun. 30, 2015 (AU) 2015902537

(51) Int. Cl. G06Q 30/06; G06Q 30/08; G06F 9/54; H04L 29/08

(52) U.S. Cl. CPC G06Q 30/0645; G06Q 30/08; H04L 67/02; G06F 9/542; G06Q 30/0641

(57) ABSTRACT

A system for use in the rental of designer clothing from a lender to a borrower is described. The system records a borrower profile and a lender profile. The borrower places a bid to rent a piece of designer clothing or makes their rental desire known to rent the piece of designer clothing for a time period that matches the respective time availability information for renting the piece of designer clothing. The rental bid is awarded to the highest bidder or to the first borrower making their rental desire known with regards to the piece of designer clothing. The borrower facilitates a payment to the lender through the use of the system and the lender delivers the designer clothing item to the borrower.

### CROSS-REFERENCE TO RELATED APPLICATIONS

This application is a U.S. Continuation-in-Part (CIP) and Non-Provisional patent application that claims priority to U.S. Non-Provisional patent application Ser. No. 15/513,111, filed on Mar. 21, 2017, which is a National Stage Entry of PCT/AU2015/000534, filed on Sep. 2, 2015, the contents of which are hereby fully incorporated by reference.

### FIELD OF THE EMBODIMENTS

The present invention relates to an improved designer clothing distribution system or process for supplying rental designer clothing to customers and clients in an efficient and cost-effective manner.

### BACKGROUND OF THE EMBODIMENTS

There has been strong demand in the marketplace for designer clothing. Typically, designer clothing is relatively expensive for regular consumers and, additionally, designer clothing may only be wanted to be worn a very limited amount of times by the consumer or purchaser. Renting designer clothing allows customers to wear designer label clothing at upcoming special or gala events, potentially for a fraction of the cost of buying and having to outlay the full purchase price of the particular piece of designer clothing. It also gives consumers the advantage of being able to quickly and easily vary their wardrobe to access sophisticated designer clothing. Furthermore, with the rapid growth of social media, which displays the outfit a customer has worn at an event, the desire to limit the amount of times the same outfit is worn and seen on social media has made designer clothing customers more sensitive to the number of times they are seen wearing the same outfit.

The benefits of designer wear rental have also been mentioned in such iconic films, such as Sex and The City™, as well as in television shows such as Oprah™. The traditional designer wear rental business model involves the requirement to purchase designer wear as inventory, then rent that inventory to the end user. The biggest restraint to this traditional business model is the ongoing need for capital to purchase a never-ending requirement for inventory. The range offered to the consumer under this model is also limited by the inventory buying ability of the business.

The traditional business model then evolved to a “sharing business model” that typically requires or focuses on physical intervention by the participants to meet up, or to physically drop off, send or deliver designer clothing, to and from, pre-determined locations or a central geographic location or other technical lending or borrowing restrictions (in addition to any transport to the end borrower). This type of business model is constrained due to logistic issues relating to the excess physical intervention of items of designer clothing, which created, amongst things, inefficiencies by double handling of the same item.

Generally, a peer-to-peer business model is a decentralized model whereby two individuals interact to buy and sell goods and services directly with each other or produce goods and service together, without an intermediary third-party. Existing peer-to-peer sharing business models do not create an efficient peer-to-peer designer clothing sharing marketplace. Furthermore, while some early sharing business models may have provided an option for management of a lenders item of clothing, this was an inefficient triple-handling model if a lender interacted with another lender to manage their item of clothing. Previously, in these sharing business models when a lender's role was viewed in isolation, they each became a traditional rental business model lender upon joining, and as described above, a constraint is the purchasing budget for items of clothing.

Thus, what is needed is an enhanced designer clothing distribution system or process for supplying rental designer clothing to customers and clients in an efficient and cost-effective manner.

Review of related art:

U.S. Pat. No. 6,885,998 describes a basic system for the rental and distribution of sporting gear to customers. This system is limited to sporting gear applications and is tailored to deliver bulk orders of sporting goods which is useful for delivering sporting goods to sporting teams but not appropriate for designer clothing.

U.S. Pat. No. 5,088,586 describes a vending machine for distribution of rental items including clothing. However, the customer is required to visit the vending machine location to pick-up the items and then must again visit the vending machine location to return the items after the rental is completed. This type of system is generally not efficient for customers and consumers as it is generally inconvenient. Additionally, people who are likely to rent designer clothing are unlikely to have the necessary time to visit a vending machine at a distant location.

Another system is proposed by a business operating a website called Good Karma Clothing™ that allows for customers to pay a monthly fee to subscribe as a member. Members are entitled to receive shipments of recycled baby clothing and once their child has outgrown the clothing, the clothing are returned and recycled again. This system is not appropriate for designer clothing as it doesn't consider that demand increases for designer clothing in accordance with the timing of special events. Also this system is tailored for use with baby clothing and leverages the system off the needs of mothers with small children or babies.

Any discussion of the prior art throughout the specification should in no way be considered as an admission that such prior art is widely known or forms part of common general knowledge in the field.

### SUMMARY OF THE EMBODIMENTS

In general, the present invention succeeds in conferring the following benefits and objectives.

It is an objective of the present invention to provide a system or process to alleviate or reduce physical intervention and/or to improve rental or distribution processes in relation to renting items or pieces of designer clothing.

It is an objective of the present invention to provide price fluctuation of rented items as an option in addition to subscription or fixed cost based business models of renting clothing, where applicable.

It is an objective of the present invention to provide all the tools, systems, and processes that are necessary to create an efficient peer-to-peer designer clothing sharing marketplace.

It is an objective of the present invention to enable designer clothing lenders to connect with other lenders or owners that may not be aware of peer-to-peer sharing, may not have time for peer-to-peer sharing, and/or may select another lender to manage their item of clothing.

It is an objective of the present invention to allow designer clothing customers to compare listings from various designer clothing rental providers.

It is an objective of the present invention to allow designer clothing rental businesses to aggregate their designer clothing rental listings into a single online web portal.

It is an objective of the present invention to provide a system for designer clothing to be rented to consumers with a method that enables clothing borrowers to compare listings from various designer clothing rental providers, in one single designer clothing rental marketplace.

It is an objective of the present invention to provide an online marketplace for the rental of designer clothing and to facilitate efficient direct transactions between lenders and borrowers.

It is an objective of the present invention to provide a marketplace for designer clothing rentals having aggregated listings from both designer clothing rental businesses and consumers with direct listings of their own.

It is an objective of the present invention to provide a marketplace for designer clothing rentals with aggregated listings from both designer clothing rental businesses and consumers with direct listings of their own, with an ability to offer those listings by way of auction or direct rental.

It is an objective of the present invention to provide a method for designer clothing to be rented peer-to-peer in a peer-to-peer sharing marketplace, which may electronically verify the identification of a renter and/or a lender.

It is an objective of the present invention to provide a method for designer clothing to be rented peer-to-peer in a peer-to-peer sharing marketplace, which may integrate data with another peer-to-peer collaborative marketplace.

It is an objective of the present invention to provide a method for designer clothing to be rented peer-to-peer in a peer-to-peer sharing marketplace that electronically integrates data with social media data or other data.

It is an objective of the present invention to provide a method for designer clothing to be rented peer-to-peer in a peer-to-peer sharing marketplace that is integrated (manually or via data integration) with a drone delivery system.

It is an objective of the present invention to provide a method for designer clothing to be rented peer-to-peer in a peer-to-peer sharing marketplace that includes an affiliate system, through affiliate software, or an affiliate network, for referrals of peer-to-peer renters and/or peer-to-peer lenders into the peer-to-peer sharing marketplace.

It is an objective of the present invention to provide a method for designer clothing to be rented peer-to-peer in a peer-to-peer sharing marketplace that records, compiles, and distributes peer-to-peer designer clothing sharing data.

It is an objective of the present invention to provide a method for designer clothing to be rented peer-to-peer in a peer-to-peer sharing marketplace that electronically verifies the credit worthiness or credit history or review ratings of a user with a third-party database or any other type of third-party electronic means of verifying.

It is an objective of the present invention to provide a marketplace for designer clothing rentals with combined aggregated listings from designer clothing rental businesses and consumers with direct listings of their own, with an ability to offer these listings efficiently and direct to each other without the use of drop-off points, pickup points, or other physical invention and constraints created by meetup points or a central location.

It is an objective of the present invention to provide a method allowing consumers to temporarily gain access to high level designer clothing.

It is an objective of the present invention to provide a method that allows a designer clothing retailer to upload or electronically send designer clothing data to the peer-to-peer designer clothing rental marketplace.

It is an objective of the present invention to provide a method that allows a designer clothing retailer to upload or electronically send designer clothing data to the backend, which communicates with the peer-to-peer designer clothing rental marketplace.

### BRIEF DESCRIPTION OF THE DRAWINGS

FIG. 1A and FIG. 1B depict flowcharts of a system or process, according to at least some embodiments disclosed herein.

FIG. 2 depicts a block diagram of system architecture, according to at least some embodiments disclosed herein.

FIG. 3 depicts a flowchart of an embodiment of a designer clothing sharing system, according to at least some embodiments disclosed herein.

FIG. 4 depicts a flowchart of another embodiment of a designer clothing sharing system, according to at least some embodiments disclosed herein.

FIG. 5 depicts a block diagram of a designer clothing sharing system, according to at least some embodiments disclosed herein.

FIG. 6 depicts a block diagram of a computing device included within a designer clothing sharing system, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As described herein, the term “sharing portal” refers to a portal in which sharing data may be accessed, or may be interchangeably used with the term “web portal.”

As described herein, the phrase “communication with the sharing portal” may be, for example, via an Application Program Interface (API), but is not limited to an API, and may be any other type of electronic or automated or any other type of communication.

As described herein, the term “designer clothing retailer” refers to an online retail outlet, a physical retail store, or an individual who possesses an item of designer clothing to rent.

As described herein, the term “sharing” may be used interchangeably with the term “borrowing.”

As described herein, the term, “sharing economy” of designer clothing may alternatively be referred to as the “on demand economy” of designer clothing.

As described herein, the term “sharing economy value” may be referred to as “peer-to-peer rental value” or “on demand value.”

As described herein, the actual owner of the designer clothing is referred to as a “lender” and their specific role is to lend designer clothing to other parties in exchange for monetary consideration. The “lender” may include the owner or controller of an item of designer clothing. In other examples, the “lender” may include the actual designer of the designer clothing, where the lender has a surplus of stock and is willing to lease the designer clothing to others.

As described herein, the definition of “user” also includes a party called a “borrower.” A “borrower” is the party or person who is willing or engages in the borrowing or leasing act for the delivery of designer clothing on a temporary arrangement from the lender in exchange for monetary consideration.

As described herein, the definition of “designer clothing sharers” means an individual who is a retailer of a designer clothing item, a purchaser of a designer clothing item, a potential purchaser of a designer clothing item, a lender of a designer clothing item, a potential lender of a designer clothing item, a borrower of a designer clothing item, or a business owning the designer clothing item. It will be appreciated that the designer clothing sharers may be a one off sharer or a return sharer of designer clothing.

As described herein, the terms “designer clothing retailer,” “designer clothing sharer,” and “designer” may be used interchangeably, where the “designer clothing retailer,” the “designer clothing sharer,” or the “designer” may be a user of the designer clothing sharing system described herein.

As described herein, the term “auction” may refer to a fixed price or purchase price that may allow a user of the system to buy or rent an item of designer clothing.

As described herein, the term “fixed price” may refer to an auction price for an item of clothing, a fixed rental price for the item of clothing, a fixed price subscription for the item of clothing, and/or a surge price for the item of clothing (e.g., when demand for the clothing item is great).

A first preferred embodiment of the present invention includes a collaborative consumption business model (also known as “peer-to-peer business model”). The peer-to-peer business model is based on sharing, or renting designer clothing and/or designer clothing accessories, directly between the users of the systems.

In this preferred embodiment, items of designer clothing are physically sent directly to the participants or users without any requirement for drop-off points, pickup points or any physical invention by a central location (in addition to the online environment and transportation). The users monetizes their own inventory efficiently and directly between each other.

This system is referred as the “sharing economy” and is experiencing phenomenal growth. Generally, the success of collaborative consumption business models has seen companies like Uber™ (transport) and Airbnb™ (accommodation) grow into multi-billion dollar companies. These types of companies allow for the sharing of items or services through web portals or mobile applications. However, these companies have never successfully applied the sharing concept to the designer clothing industry and have never engaged any business model that enables a direct peer-to-peer sharing of designer clothing rentals, such as the system or process described herein. Moreover, these companies have not solved the inherent problems specific to an efficient designer clothing sharing system.

The first preferred embodiment of the present invention described herein is designed to deliver a rental auction or price-surge based system or process where borrowers compete to rent designer clothing from lenders, as an optional capability, in addition to a fixed-price based rental system or process. The advantage of this embodiment is that borrowers often like to rent designer clothing for special events and these special events occur at fixed times. Previous systems and processes that rely only on subscription or fixed price based business models are not as efficient, as these models do not take into account the true market forces of supply and demand.

Typically, supply of designer clothing is limited and, therefore, the price of the designer clothing fluctuates with the force of demand. The force of demand, in the case of designer clothing, is generally determined by the need for designer clothing at special events. For example, if a special gala event is being held in a city in a particular night, many borrowers will require designer clothing for the event and they will all be competing for similar designer clothing items at the same time. This, in turn, will force an increase in the price to rent the item of designer clothing in accordance with demand pressure, and previous designer clothing distribution systems and processes, without the optional capability of a price surge mechanism, are not able to address this market inefficiency.

Alternatively, the number of events in a location is typically lower during the mid-week periods and therefore, the price to rent the item of designer clothing would normally be expected to fall during this time period due to lower customer demand. Previous designer clothing distribution systems and processes are not able to address this market inefficiency. The market force exhibited by supply side forces is relatively inelastic, as the supply of designer clothing items is not expected to significantly change in a short term analysis.

The first preferred embodiment of the present invention employs a collaborative consumption business model and may be based in a purely online operating through an Internet portal or website. The system or process is preferably event-based (one-off hire each time) business model, and it is the only provider or lender that has introduced an online auction, specifically customized and built for designer clothing rental.

The embodied process or system may allow borrowers to rent their designer clothing directly from a lender. Users may include a lender and/or a borrower. Preferably, the process or system works on a transactional basis and requests a first payment on behalf of the lender from the borrower once the bidding for the item of designer clothing has been finalized. The system or process then makes a second payment to the lender or acknowledges it has facilitated a direct secure payment between the borrower and lender. The payment by the borrower is facilitated by the system or process, to cover delivery costs, any insurance costs and commissions of the system/process operator.

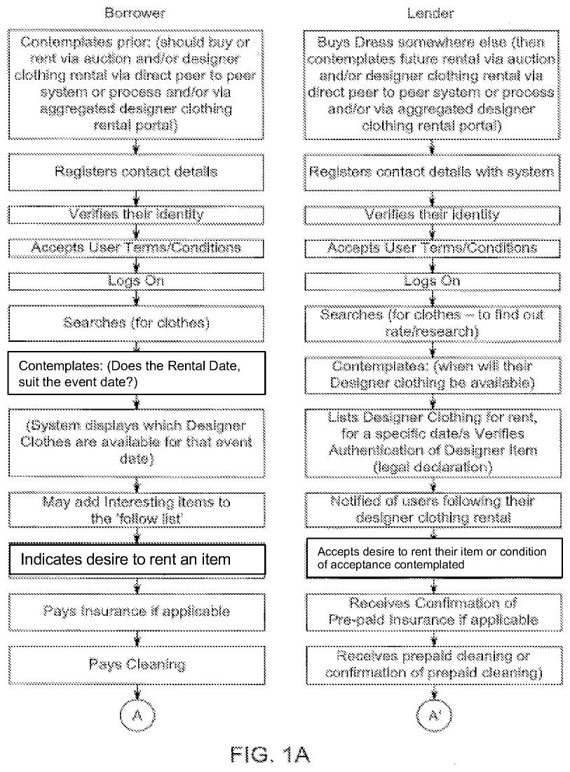

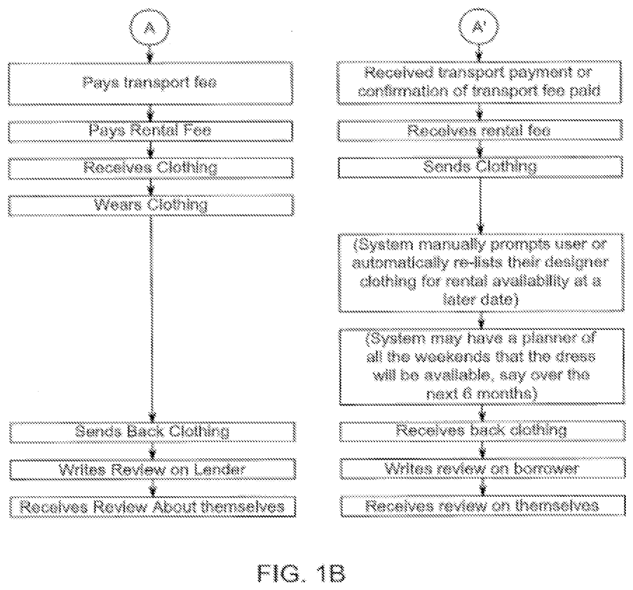

The system and process is described in FIG. 1A and FIG. 1B, where a flowchart has been provided to identify some of the various steps and stages involved within the first preferred embodiment. It should be appreciated that the flowchart of FIG. 1A is continued in FIG. 1B. The flowchart of FIG. 1A and FIG. 1B is divided into two main areas of processing, which occur side by side or simultaneously throughout the preferred system or process. Initially, both of the lender and borrower visit a website or Internet portal running software that incorporates the first preferred embodied system or process. The lender and borrower both agree with the system terms and conditions and enter basic contact information about themselves, including, but not limited to: name, address, mailing address, email address, phone numbers, credit card details, payment details, country or jurisdiction locating information. The respective information from the lender or borrower is stored by the system in a respective lender or borrower profile.

The lender profile also stores information regarding lists of designer clothing that is available for renting and the respective time period availability information for each piece or article of designer clothing. The lender profile may also store example photos of the designer clothing, videos of a user wearing the designer clothing, and brief textual descriptions of the item of designer clothing, including: item type (e.g., accessories, shirts, shorts, dresses, outerwear, sandals, swimwear, lingerie, shoes, etc.), item designer/manufacturer, size, color or colors, rental price, rental availability, occasion (e.g., black tie, activewear, beachwear, date night, formal, wedding, bridal wear, business casual, casual, etc.), etc.

The borrower profile stores information primarily about the borrower and their contact details. The borrower profile may also store additional information about the borrower's sizing or clothing preferences. These clothing preferences may include information such as: I prefer male or female clothing, and I like/dislike hats/shoes, etc. Borrower's may utilize the system or process to search the lender's profile for a list of appropriate designer clothing for which they may wish to borrow. Specifically, the borrower may search the databases and profiles based on fields including, but not limited to: item type (e.g., accessories, shirts, shorts, dresses, outerwear, sandals, swimwear, lingerie, shoes, etc.), item designer/manufacturer, size, color or colors, category (e.g., menswear, womenswear, childrenswear, etc.), condition (e.g., new with tags, new without tags, like new, gently used, well loved, vintage, etc.), rental price, rental availability, occasion (e.g., black tie, activewear, beachwear, date night, formal, wedding, bridal wear, business casual, casual, etc.), etc.

Further improvements to the process and system may include allowing individual designers of designer clothing to act or become direct lenders of their unique designed clothing. This may give an additional advantage of cross-promoting designers and designer clothing directly to interested parties as the lists of borrowers.

Preferably, the system includes basic website security and protects the privacy of users. Exact details of the other users are only visible once the transaction has been completed. Prior to completion of the transaction, users may only see basic information of other third party users. Specifically, protected information may include the real names, real addresses, and real emails of the users. Specifically, the system described in the flowcharts accepts registrations from lenders or borrowers. The lenders and borrowers are verified by the system, then they individually accept the terms and conditions associated with the system.

In an example scenario, once the borrower has chosen a preferred item of designer clothing to rent, the borrower may place a bid for the item of designer clothing and if applicable, by a specific time. Other borrowers may simultaneously bid on the same item, where the each subsequent bid must be higher than the earlier bid. Preferably, the system monitors real-time availability of the items or pieces of designer clothing to ensure their availability for bookings and events. The time availability may be displayed in a graphical interface which is overlayed with a calendar showing the available and already booked and rented days and time frames.

In some embodiments, bidding for an item of designer clothing may also include committing to buy or rent an item of designer clothing at a fixed price. The term auction may also mean buying or renting an item of designer clothing at a fixed price. In some examples, the system may close bidding to the online auction at some minimum predetermined time. This predetermined time is typically the minimum time needed to deliver the items to the borrower (e.g., 2-3 days or 2-3 months) prior to the use or rental date so that the borrower can use the item of designer clothing at a function or event. However other minimum time frames may be adjusted by the lender. The system evaluates which borrower has made the highest bid prior to the closing time or date of the online auction for the item of designer clothing. Typically, the lender may be required to agree to deliver the items of design clothing by the nominated delivery date or forfeit the monetary consideration.

The preferred system may then require the successful winning borrower to make a first payment. The preferred first payment includes: the fees payable to the lender, fees for insurance of the item if it is lost or damaged, cleaning costs, delivery or transport fees and system commission fees. The first payment may be a direct payment between borrower and lender, facilitated by system, or if it is a payment to the system, then the system pays a second payment to the lender and this second payment typically only includes fees payable to the lender.

Delivery fees are paid or facilitated by the system from the money supplied by the borrower. The delivery fees cover: delivery to the borrower and return delivery fee of returning the item to lender. Preferably, the system may produce pre-printed delivery packages or labels suitable for the initial delivery to the borrower and return trip back to the lender. Preferably, these packages or labels are arranged so as to expose the first delivery address of the borrower and then easily be modified to expose a second delivery address of the lender. The delivery packages may be reused and the system may preferably organize for courier deliveries and pickups to the specified addresses of the respective parties. The pre-printed labels on the packages reduce the likelihood that the packages are incorrectly delivered to the wrong address. The payments may be also handled by a third-party payment technology, such as, but not limited to Paypal™, or others however the processing of the payment is facilitated by the embodied system and the system will handle the necessary servers negotiations with the Paypal™ or others technology/system.

Preferably, the system may produce and electronically deliver a custom three-dimensional (3D) printing file to the lender and/or borrower. This enables the lender and/or borrower to print a custom 3D printed package or print a custom 3D label using a 3D printer connected to the computer that lender and/or borrower is using. Preferably, the 3D printing file includes electronic instructions or a code adapted to allow the 3D printer to print 3D objects, including labels and packages for use with the system.

Preferably, the cleaning costs are covered in a payment to the lender, where the lender has agreed to fixed or minimum cleaning costs as part of the aforementioned terms and conditions of the system. Preferably, the lender is responsible for cleaning the items of designer clothing once they are returned after the transaction is complete. Alternately, the borrower may be required to clean the items of designer clothing prior to their return to the lender. The operation of the responsibility of cleaning is generally agreed between the lender and borrower prior to activating the transaction.

The preferred process or system is described in detail in FIG. 1A and FIG. 1B. The process demonstrates some preferred steps operating in tandem or simultaneously between the lender and/or borrower. Generally, the process includes: a user verification and security check wherein the user being the lender or borrower verify their identity to the system. The lender may make a listing on the system for each item of designer clothing. Other users are notified of the listing by the lender, this notification may take the form of an email notification or a general untargeted advertisement on the system.

The item of designer clothing listed by the lender may be available to auction or available for its price to surge according to fluctuating user demand. Preferably, the lender may set a predetermined reserve or minimum starting price that they are willing to accept for the transaction. Alternately, the lender may opt for a fixed price auction where the item of designer clothing if offered at fixed price or static price subject to availability. Prospective borrowers compete to bid on the auction for the rental of the item of design clothing. If the reserve price is met, the highest bidder from the borrowers is selected as the winner of the auction. The winning borrower is then contacted by the lender or system to process payments. In additional examples, the item of designer clothing may be listed with a direct borrower price that is not subjected to an auction.

Preferably, the system or process may also include an item verification step where each particular listed item of designer clothing is authenticated as being an original item from that the designated designer. This verification step may take place as a legal declaration or a verification check by system operator confirming that the item is genuine.

Another improvement may to allow for advertising or preferential recommendations to be supplied to potential borrowers, where the system automatically alerts or messages potential borrowers to the availability of special designer clothing or designer clothing of a preferred size or type that matches the borrower profile information.

Although FIG. 1B makes specific reference to “weekends” other dates and times may be flexibly handled and managed by the system. Preferably, the system may include optional steps whereby the lender or borrower performance throughout any given transaction is able to be reviewed and commented on and the reviews and comments are available to general users of the system. The reviews may take the form of star ratings out of a maximum of 5 stars, positive percentages between 0% for a negative review and 100% for a positive review, may be comment driven, and/or any other format.

Preferably, the system is adapted to facilitate the delivery of the items or pieces of designer clothing direct to the physical location which is predetermined by the borrower. The borrower may elect a predetermined delivery address, rather than the prior art systems that rely on drop-off points, pickup points, or intervention by a central location (in addition to transportation). Preferably, the present system does not include pickup or drop-off points or physical intervention by a central location (except transportation), since physical intervention unnecessarily increases the cost of each transaction, reduces the usability and efficiency of the system, and adversely places an undue burden and great inconvenience on the borrower to arrange for the items or pieces of designer clothing to be gathered from the pickup or drop-off location or delivery to/from the central location.

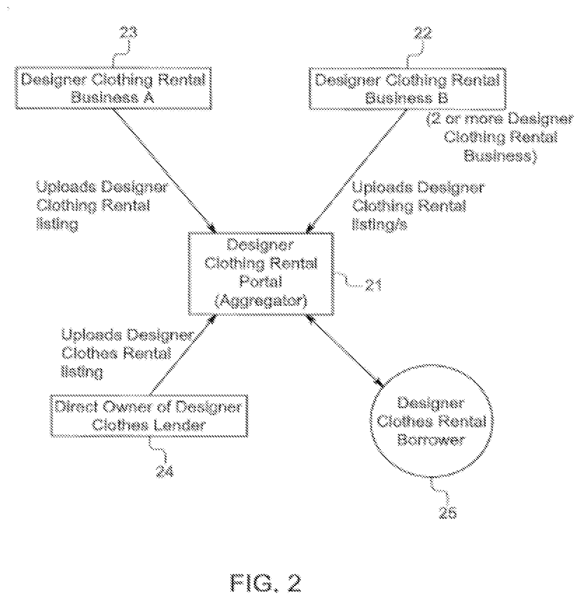

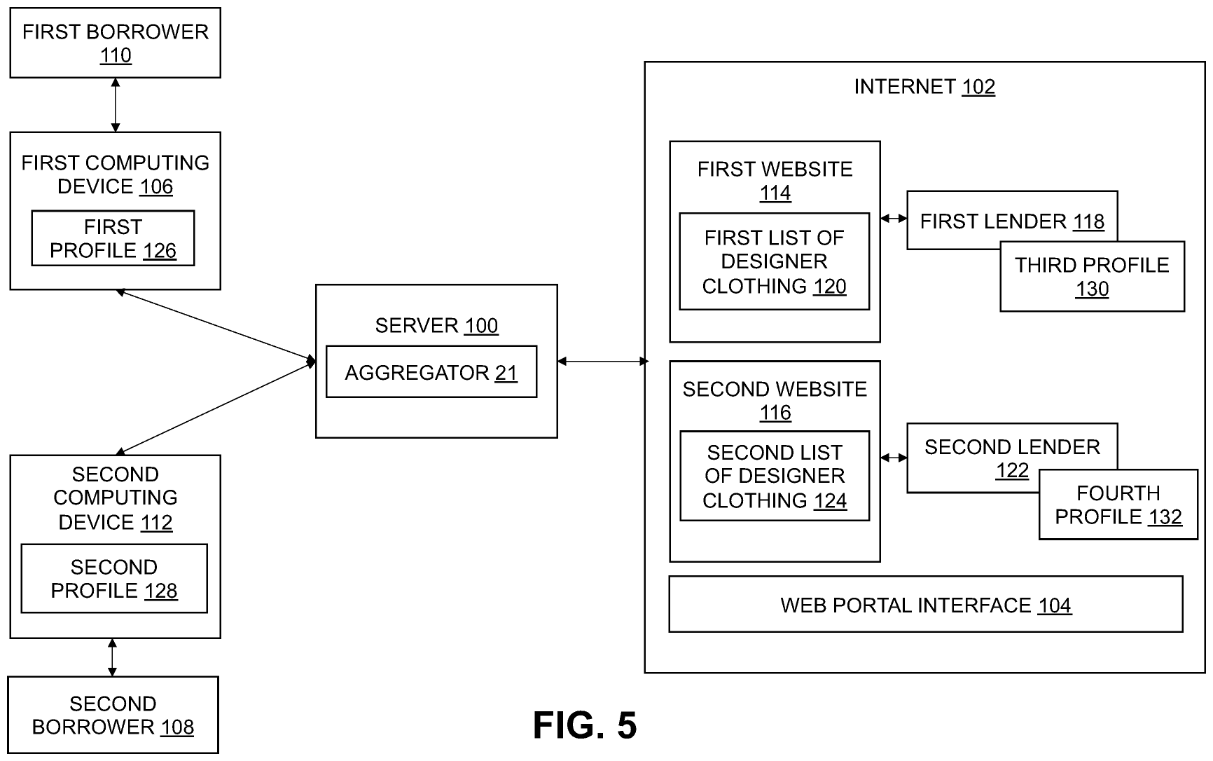

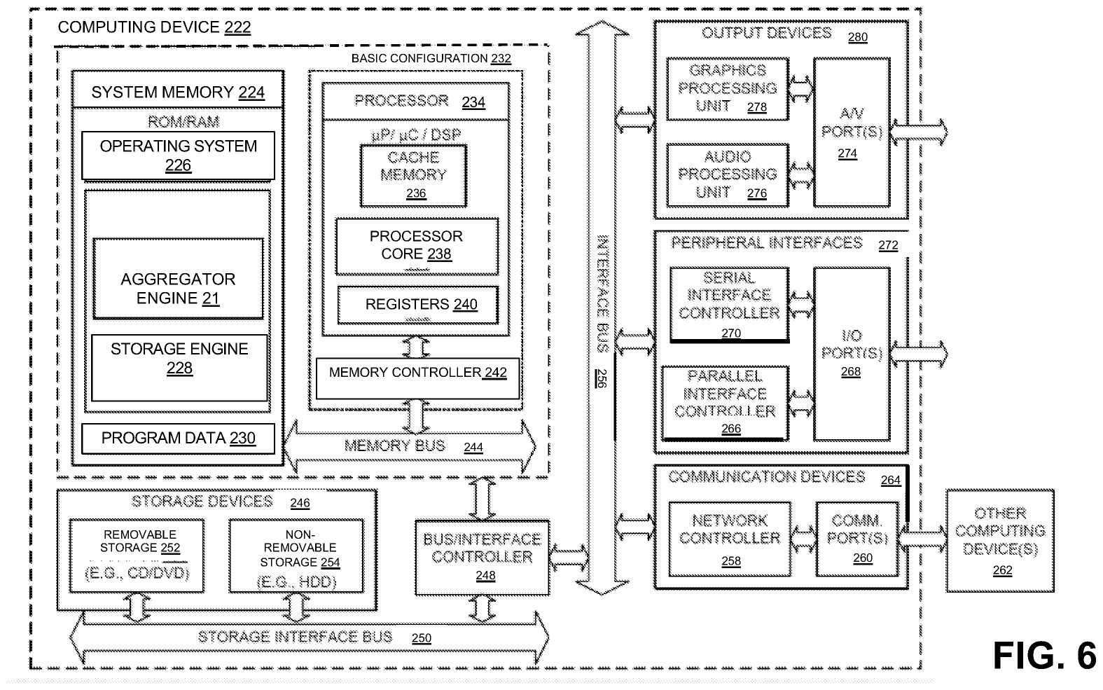

FIG. 2 depicts an expanded system or process architecture, where the diagram shows the above-described process or system of the first preferred embodiment illustrated with reference to FIG. 1A and FIG. 1B being run or managed by a web portal. The web portal is preferably an aggregator 21, which interacts and manages the processes of the first preferred embodiment using code adapted to run on internet browser via the Internet. The aggregator 21 is preferably an Internet web portal operated by software operating on an Internet server. It should be appreciated that in other examples, the aggregator 21 may be configured to be operated by software executed on the Internet server. In other examples, the aggregator 21 may be an application, an engine, a software program, a service, or a software platform configured to be executable on a computing device, as described in FIG. 5 and FIG. 6 herein. The aggregator 21 administrates the process and transaction and interacts with various user and user types.

In FIG. 2, the aggregator 21 interacts with three different listing groups or types of lenders, and these preferably are: Designer Clothing Rental Business A 23, Designer Clothing Rental Business B 22, and a direct owner of designer clothing or controller of the items 24. All of these types or groups of lenders may simultaneously list items of designer clothing to be advertised on the aggregator 21 for rent. Designer Clothing Rental Business A and Designer Clothing Rental business B are the same type of designer clothing rental businesses and are listed as A and B to represent multiple users of that same type. There may be also multiple users of 24 and 25.

Preferably, the aggregator 21 automatically data-mines the lists of designer clothing items directly from the lender group, where the lender is a business or an owner of designer clothing. Specifically, the aggregator 21 may visit a website or a server address on the Internet of a lender group and may detect various items of designer clothing to be listed. The aggregator 21 may detect certain fields of data to be mined from the lender's website including: item details, availability details, costs, condition of item, item description, photos of the item, etc. The aggregator 21 may then replicate the listing information detected and identified from the lender's website and may republish the information with the verification and consent of the lender group, if consent is required.

The borrowers 25 interact with the aggregator 21 by browsing the rental designer clothing listings shown on the displays of the aggregator 21 and the borrowers 25 may then interact with the aggregator 21 to process the transactions by a similar process as described in reference to the first preferred embodiment and FIG. 1A and FIG. 1B. Preferably, the system or process shown in FIG. 2 may be adapted to different composition mixes of lenders whereby: the system includes only direct designer clothing owner—lenders 24 and does not include rental businesses A or B.

It should be appreciated that in other examples, and as depicted in FIG. 5, the system for use in a rental of designer clothing between lenders and borrowers may include numerous components, such as: a server 100, a first website 114 housed on the Internet 102, a second website 116 housed on the Internet 102, a first computing device 106 associated with a first borrower 110, a second computing device 112 associated with a second borrower 108, and a web portal interface 104.

The first website 114 is associated with a first lender 118 and includes information associated with a first list of designer clothing 120 to be rented. The second website 116 is associated with a second lender 122 and includes information associated with a second list of designer clothing 124 to be rented. The information associated with the first list of the designer clothing 120 and the second list of the designer clothing 124 comprises at least a time period that each piece of the designer clothing is, or will be, available for rent, a description of associated with each piece of the designer clothing, and an image associated with each piece of the designer clothing.

The aggregator 21 is configured to perform numerous process steps, such as: data mine the first website 114 and the second website 116 to detect items from the first list of the designer clothing 120 and the second list of the designer clothing 124 and detect at least the time period that each piece of the designer clothing is available for rent and the image associated with each piece of the designer clothing from the first list of the designer clothing 120 and the second list of the designer clothing 124. The aggregator 21 is also configured to capture or enable data uploaded from another database containing specific details relating to each piece of the designer clothing that will be made available for rent, such as clothing description and images.

The aggregator 21 may also detect, in real-time, an amendment to or an addition of information associated with the first list of the designer clothing 120 and/or the second list of the designer clothing 124. The aggregator 21 is further configured to: replicate/mirror an extract or a version of the extract of the first list of the designer clothing 120 and the second list of the designer clothing 124 for display on the web portal interface 104.

Further, in some examples, the aggregator 21 may set a minimum starting value for a bid on the first item from the first list of the designer clothing 120 during the bidding process. Next, in response to the first borrower 110 and the second borrower 108 searching the extract replication on the web portal interface 104, the aggregator 21 is configured to receive, from the first borrower 110, the second borrower 108, and/or a third borrower (not shown), a bid to rent a first item from the first list of the designer clothing 120 for a first time frame. The aggregator 21 may also receive from the first borrower 110, the second borrower 108, and/or a third borrower acceptance of an option to subscribe to ongoing bids. In another scenario, the item of designer clothing may not be subjected to auction. In this case, the aggregator 21 may receive an acceptance of the listed borrower price for the item of designer clothing.

Then, the aggregator 21 is configured to identify, in real-time, that the first time frame is within the time period that the first item from the first list of the designer clothing 120 is available for rent and close the bidding process temporarily or permanently after an amount of time has lapsed (that may be predetermined or is user-customizable) or an event has been triggered.

In a first scenario, the aggregator 21 detects that there is only one bid. In this first scenario, the aggregator 21 is configured to notify the winning borrower (e.g., the borrower who made the bid) of their successful bid to rent the first item from the first list of the designer clothing 120 for the first time frame.

In a second scenario, the aggregator 21 detects that the bid associated with the second borrower 108 is greater than or equal to the bid associated with the first borrower 110. If the bid associated with the second borrower 108 is greater than the bid associated with the first borrower 110, the aggregator 21 is configured to notify the second borrower 108 of a winning bid to rent the first item from the first list of the designer clothing 120 for the first time frame. If the bid associated with the second borrower 108 is lower than the bid associated with the first borrower 110, the aggregator 21 is configured to notify the first borrower 110 of a winning bid to rent the first item from the first list of the designer clothing 120 for the first time frame.

If the bid associated with the second borrower 108 is equal to the bid associated with the first borrower 110, the aggregator 21 is configured to (a) notify the first lender 118 and allow the first lender 118 to select which borrower is the winning borrower or (b) select the winning bidder as the bidder who submitted the bid first. Next, the aggregator 21 is configured to notify the winning borrower of the winning bid to rent the first item from the first list of the designer clothing 120 for the first time frame.

Next, the aggregator 21 receives a payment from the winning borrower. The payment may include a security deposit, an insurance cost, a cleaning cost, and/or a delivery cost. In some examples, this payment is a partial payment for the rental price of the item of designer clothing. In other examples, this payment is a full payment for the entire rental price of the item of designer clothing.

The aggregator 21 then transmits the payment to the first lender 118. In response, the first lender 118 is configured to deliver the first item from the first list of the designer clothing 120 directly or as facilitated by the aggregator 21 to the winning borrower for a start of the first time frame. It should be appreciated that the delivery of the first item from the first list of the designer clothing 120 to the winning borrower for the start of the first time frame occurs without a need for a drop-off point, without a need for a central storage, and without a need for a processing hub.

Then, the first item from the first list of the designer clothing 120 is cleaned by the winning borrower prior to returning the first item from the first list of the designer clothing 120 cleaned upon a conclusion of the first time frame. In another scenario, the first item from the first list of the designer clothing 120 is cleaned by the first lender 118 responsive to receiving the first item from the first list of the designer clothing 120 after the conclusion of the first time frame.

The aggregator 21 is also configured to record a first profile 126 associated with the first borrower 110, a second profile 128 associated with the second borrower 108, a third profile 130 associated with the first lender 118, and a fourth profile 132 associated with the second lender 122. Each of the first profile 126, the second profile 128, the third profile 130, and the fourth profile 132 include review information submitted by third parties and/or comments about performance of the respective party. The aggregator 21 may also record the first profile 126 or the second profile 128 as being the winning bidder and update the first profile 126 or the second profile 128 accordingly.

In other scenarios, when a clothing purchase is made through an online clothing retailer, the aggregator 21 is configured to recognize and extract clothing information, such as description and images, for clothing that will be made available to rent after purchase. Next, the aggregator 21 matches this data with clothing rental availability data that has been inputted into the aggregator 21 as confirmed by the clothing owner (e.g., the first lender 118 or the second lender 122), such as a time period the item of clothing is available for rent. Next, the aggregator 21 sorts and displays this data in a way that can facilitate the rental of the clothing item online. Such may be considered a “recommendation” by the aggregator 21. In some examples, this process may occur via an application programming interface (API), which is a computing interface that defines interactions between multiple software intermediaries. In other examples, this process may occur through any other means of transferring the data between one computer database to another.

In additional scenarios, when a clothing purchase is made through the online clothing retailer, the aggregator 21, automatically and in real-time, is configured to calculate a suggested rental price for the item of clothing. This suggested rental price may be based on the purchase price of the item of clothing and/or other market factors relevant to renting. The aggregator 21 then, automatically and in real-time, displays the suggested rental price to the first borrower 110 and/or the second borrower 108. In some examples, this process may occur via the API or any other means of transferring the data between one computer database to another.

In another scenario, an individual clothing owner (e.g., the first lender 118 and/or the second lender 122) may upload information (e.g., text descriptions, images, video, etc.) about the items of clothing the individual clothing owner has for rent directly into the aggregator 21. Then, the aggregator 21 arranges the item of clothing with other items of clothing already available for rent, making the uploaded item of clothing searchable by: item type (e.g., accessories, shirts, shorts, dresses, outerwear, sandals, swimwear, lingerie, shoes, etc.), item designer/manufacturer, size, color or colors, category (e.g., menswear, womenswear, childrenswear, etc.), condition (e.g., new with tags, new without tags, like new, gently used, well loved, vintage, etc.), rental price, rental availability, occasion (e.g., black tie, activewear, beachwear, date night, formal, wedding, bridal wear, business casual, casual, etc.), etc.

Previously, in the event that a designer clothing retailer was in the process of selling an item of designer clothing, either online or otherwise, or was in the process of sharing an item of designer clothing, there was no method for the retailer to view the potential future sharing economy value of the sold or shared item of clothing. Further, there was also no automated method for calculating the potential future sharing economy value of a sold or shared item of clothing or designs similar thereto. There are a number of significant advantages associated with calculation of the sharing economy value.

Calculating a sharing economy value for an item of clothing may increase the overall profits of the designer clothing retailer. For example, if an item of clothing was to be listed as $X, the retailer could maximize profits by using a calculated sharing economy value $Y instead, which may be calculated from at least one data set associated with the item of designer clothing. Using the sharing economy value $Y during the sales process may allow a retailer to maximize the sales price and/or to increase the number of units sold of that designer clothing item. The purchaser may also see the additional benefit of the sharing economy value ($Y-$X) and can use it to maximize their potential future sales or rentals of the item of designer clothing. The data used to derive $Y may be from similar items of designer clothing or accessories that have been rented in the past, to predict the future sharing economy value or an estimated range of that value.

In another embodiment, the sharing economy value may determine whether an item of designer clothing should be sold or have the price decreased or increased before being sold. This sharing economy value may be based on the frequency by which the item of designer clothing is successfully rented in the past, or the frequency in which similar items of clothing are successfully rented, or being shared or being used on demand. This sharing economy value may be an indicator of fashion trends changing and usage longevity of designer clothing items. Calculating this sharing economy value may maximize the potential sales of the retailer, as at least one of the retailer or purchaser becomes aware of the designer clothing item's potential sharing economy value during the sales process, a benefit they previously were not advised of, as part of the sales process.

Also the sharing economy value is a value assigned to an item of designer clothing which may be calculated based on data assigned to the item of designer clothing, or may be based on data from other items of clothing similar to that of the item of designer clothing. The sharing economy value may be calculated by the designer clothing sharing system, and may optionally be displayed on a display device to a user. The sharing economy value may be one of a numerical scale value, a monetary value or otherwise any descriptor that may factor a potential future value of the item.

In one example, the item of designer clothing may be assigned a word value or similar qualitative value such as: very good, good, average, poor or very poor. This sharing economy value may subsequently be used to indicate the likelihood of future sharing of the item of designer clothing or otherwise be used to factor a predicted sharing economy value previously assigned to the item of clothing in which the word values are assigned a weighting factor. For example, if an item of clothing was assigned an original sharing economy value of $100 and the item of clothing has a “good” value with a factor of 0.9 the new value of the clothing would be $100×0.9=$90. However, other factors or predetermined values may be used to calculate the sharing economy value.

It will be appreciated that a user of the designer clothing sharing system may be a designer, a designer clothing retailer, a designer clothing sharer or the like. It will be appreciated that the calculated sharing economy value may be a comparison of at least one data set value assigned to the item of clothing and at least one predetermined value stored on a storage means by the designer clothing sharing system. The storage means may be, for example, a server, an internet server or cloud based storage means, or any other suitable means for storing data. The designer clothing sharing system and process for calculating the sharing economy value is not limited to the above examples and other factors, condition status, predetermined values or data sets may be used to calculate the sharing economy value. The sharing economy value may be stored on the designer clothing sharing system or process for at least one of; further calculations, cross referencing to other items of designer clothing, used as item history, or otherwise stored on the storage means in communication with the designer clothing sharing system or process.

In some examples, the aggregator 21 described herein is configured to identify a sharing economy value for each piece of the designer clothing associated with the first list of the designer clothing 120 and/or the second list of the designer clothing 124 based on a frequency by which each piece of the designer clothing has been successfully previously rented such that the sharing economy value is greater in response to a higher frequency. Moreover, in other examples, the aggregator 21 is configured to identify the sharing economy value for each piece of the designer clothing associated with the first list of the designer clothing 120 and/or the second list of the designer clothing 124 based on data from other similar items of clothing.

The aggregator 21 may also identify the sharing economy value for each piece of the designer clothing associated with the first list of the designer clothing 120 and/or the second list of the designer clothing 124 based on a likelihood of future renting of each piece of the designer clothing. Moreover, the aggregator 21 may identify the sharing economy value for each piece of the designer clothing associated with the first list of the designer clothing 120 and/or the second list of the designer clothing 124 and may display this value for each piece of the designer clothing via the web portal interface 104 to each of the first borrower 110 and/or the second borrower 108. In some embodiments, the aggregator 21 may automatically and in real-time update the sharing economy values of the item of designer clothing based on new data, such as a higher demand for the item of clothing.

Previously, in the event that a designer clothing retailer was in the process of selling an item of designer clothing, either online or otherwise, there was no automated method for the retailer to view the potential future sharing economy value of the sold or shared item of clothing. Further, there was no automated method for calculating the potential future sharing economy value of a sold or shared item or clothing or designs similar thereto.

The designer clothing sharing system described herein allows the designer clothing sharer to enter a description for an item of designer clothing. This description may be entered manually or by a known scanning method of a retail barcode, an identifier, or by API or by any other automated or electronic means. The designer clothing sharing system subsequently assesses at least one desired data set related to the designer clothing, such as rental data or peer-to-peer sharing data or any other predefined data set. The designer clothing sharing system may be configured to display the assessed data on a display which may show at least one of; a potential future transactional rental estimate, a sharing economy estimate, a rental history, and a sharing history of that item of designer clothing, or items of designer clothing similar to that of the item of designer clothing which has been entered into the designer clothing sharing system, similar to that of a designer clothing retailer.

In yet a further embodiment, the designer clothing sharing system or process enables a designer to upload or electronically send designer clothing data to the designer clothing sharing system. The data may include one or more data sets including: images, descriptions, or purchaser contact details, or any other predetermined data sets desired by the user into the designer clothing sharing system. The data gathered may be aggregated with at least one data set associated with the item of designer clothing and may be used to calculate the sharing economy value of the item of designer clothing. It will be appreciated that the data may be uploaded or sent prior to, or after selling a designer clothing item or accessory, either online or offline. The uploaded or sent data may be sent directly to the publicity viewable sharing portal or to the backend of the designer clothing sharing system in communication with the sharing portal, similar to that of the designer clothing retailer.

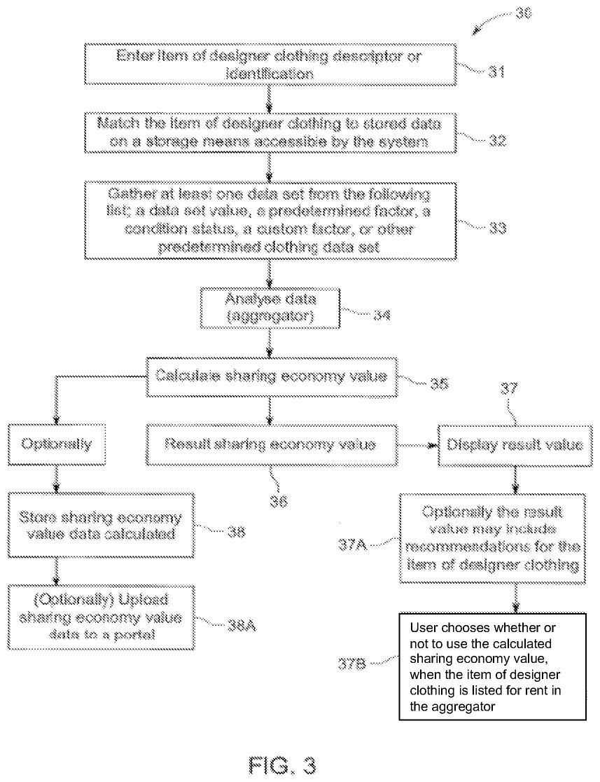

FIG. 3 depicts a flowchart 30 of the designer clothing sharing system. The FIG. 3 shows an embodiment of the above-described designer clothing sharing system, in which an item of designer clothing descriptor or identification is entered into the designer clothing sharing system 31. The system then matches the item of designer clothing with the data of the item of designer clothing stored on a storage means 32 accessible by the designer clothing system. The designer clothing sharing system may then gather at least one further data set 33 from the following list: a data set value, a predetermined factor, a condition status, a custom factor, or other predetermined clothing data set. The item of clothing data and the gathered data may then be analyzed or aggregated 34. The aggregated data may then be used to calculate a sharing economy value data 35 associated with the item of designer clothing. The result sharing economy value 36 is then produced and may be displayed 37 on a display device. The displayed sharing economy value may also display a number of recommendations for the item of designer clothing 37A based on the sharing economy value, such as a recommended auction price or rental price. These recommendations may then be used for a rental auction or for a fixed price rental of an item of designer clothing 37B. Optionally, the calculated sharing economy value data may be stored on a storage means associated with the designer sharing clothing system 38. The stored sharing economy value data may also be uploaded to a web portal 38A and stored on a web server.

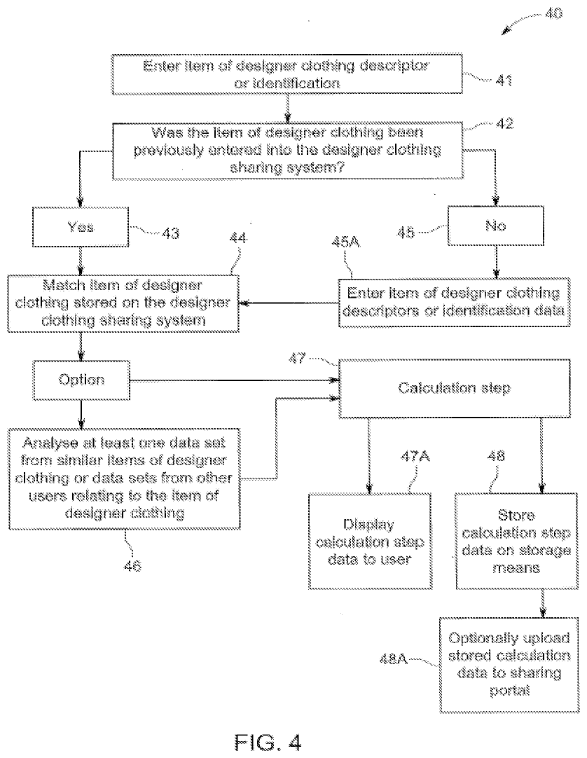

FIG. 4 depicts another embodiment of the designer clothing sharing system 40. FIG. 4 displays entering an item of designer clothing descriptor or identification into the designer clothing sharing system 41. The system checks whether the item of designer clothing has previously been entered into the system 42. If the item of designer clothing has been entered into the designer clothing sharing system 43, the item of designer clothing is matched to the stored data on the designer clothing sharing system 44. If the item has not been entered into the designer clothing sharing system 45, the item of designer clothing descriptors or identification data is entered and stored into the designer clothing sharing system 45A and the designer clothing sharing system is then matched to the stored data on the designer clothing sharing system, similar to that if the item of designer clothing had been entered into the system.

After matching, the system may optionally analyze at least one data set from the following list 46: data from similar designer clothing, data sets from other users relating to the item of designer clothing, and stored data sets related to the item of designer clothing. At least one data set for the item of designer clothing may then be calculated at a calculation step 47 with reference to the matched data and/or any other optional data sets. The data set calculated at step 47 may include a sharing economy value, a data set from similar items of designer clothing (such as images or descriptions), previously displayed data from auctions or sales for an item of designer clothing, or any other desired data set. The data set may then be displayed to the user on a display device 47A. In this embodiment the calculated data set may be stored on a storage means 48 associated with the designer clothing sharing system. Optionally, the stored sharing economy value data may be uploaded to a web portal 48A and stored on a web server.

In yet another embodiment, lenders or borrowers may associate their username or details associated with the designer clothing sharing system with an item of clothing. This association may issue a notification, such as a text message, sound notification, email, a push notification, or any other type of notification, to the lender or borrower when a desired item of designer clothing is up for sale or for rent. This allows a borrower or lender to track or otherwise monitor a desired item of designer clothing. Associating a lender or a borrower with a designer clothing item, and may place the lender or borrower on a short list for the borrower or lender to transact with each other or to indicate demand for that item of designer clothing.

In previous prior art devices, systems and processes, the pick-up points for items of designer clothing delivered through similar system may have been dictated or predetermined by the lender or system. This may essentially mean that the pick-up points were previously convenient for only lenders or system operators but not for the borrower. The present embodiments preferably deliver the items of designer clothing direct to borrower without the need for pick-up or drop-off points. The transportation of the items of the designer clothing is preferably facilitated directly between the lender's chosen address and the borrower's chosen address which may remove the need for central storage or processing hubs which system operators may have previously run or managed to store the items prior to delivery and pickup.

Previously, there has not been a system of connecting a peer-to-peer network of potential managers of rental items of designer clothing that may each be limited by inventory constraints. Additionally, a network of peer-to-peer designer clothing owners may be limited by constraints, such as time or management difficulties, in the designer clothing sharing industry. At least one of the above embodiments may alleviate the inventory purchasing constraints of a peer-to-peer rental lender, with peer-to-peer designer clothing borrowers that may be limited by effort and time management constraints. The present embodiment enables an individual lender the option to assign an item of designer clothing, to be managed by a rental business lender or any other lender (business or individual) that are available to manage designer clothing owned by another party or parties. The rental business lender may then receive a commission for managing the at least one item of designer clothing on behalf of the designer clothing owner. This may enable the designer clothing sharing and rental industry to operate in a more efficient manner.

In at least one embodiment, a renter or lender may require uploading or submitting a form of suitable identification (ID). Suitable ID may comprise at least one of a name and a date of birth. A form of suitable ID may be at least one of; a social security number, a tax file number, a government issue ID, government ID, or other type of ID or ID Data or Personal ID or Business ID Data, a driver license, a utility bill, a letter, a passport, or any other form of predetermined identification. The system may be adapted to electronically validate at least one form of suitable ID. The standard of ID verification may be compliant with ‘Know Your Customer’ regulation or anti money laundering regulations. In some examples, the aggregator facilitates an electronic identification (ID) verification of each of the first lender, the second lender, the first borrower, and the second borrower.

In another embodiment, a social media profile or account profile of at least one of the renter and the lender may be associated with the system of the present disclosure. More particularly, the system of the present invention may associate at least one data set from at least one of a sale history, a transaction history, a reputational history, review data, pending or previous transaction data or any other predetermined data set associated with at least one of a social media account, a user account or a user history, such data from as eBay™, an Etsy™, Google™, AdWords, or Facebook™, for example. This provides the advantage of a previously built reputation to be established on the new website and may assist a renter or borrower to gain a sales advantage if they have already established an online account elsewhere.

Further, if the system is configured to allow at least one social media account to be associated with a peer-to-peer designer account, the at least one social media account may be used by the system to promote or otherwise provide ads to at least one of the social media accounts. For example, a user of the system with an associated social media account may tag at least one of friends, contacts and connections who may be interested in renting or purchasing items of designer clothing. In addition, the system may also be adapted to allow a user to import or associate images or videos from a social media website or account for use with a designer clothing sale or auction. In a further embodiment, the system may allow at least one of clothing comments or designer clothing votes or likes from social media, or import designer clothing hashtags, or event hashtags, or designer clothing descriptions, or designer clothing trends from social media.

In yet another embodiment of the present disclosure, the system may optionally be adapted to record, compile or distribute at least one data set. The data may be distributed to at least one user of the system or to a third party. The at least one data set may include real-time sharing data such as a running total of peer-to-peer designer clothing sharing savings or an ongoing running total of designer clothing sharing lending income.

At least one data set may optionally be reset either manually or at predetermined time intervals. This reset may be irrespective of an amount paid or a balance owing to a lender. At least one data set may also include dress data which is specific to peer-to-peer designer clothing sharing. Another peer-to-peer data set may include items such as the highest number of designer clothing peer-to-peer sharing between defined peer-to-peer geographic locations, the most popular peer-to-peer designer clothing sharing dresses, the most profitable peer-to-peer designer clothing sharing dresses, the most versatile peer-to-peer designer clothing sharing dresses.

In at least one further embodiment, the system of the present invention may allow delivery of an item of clothing by a drone or other autonomous delivery system.

In yet another embodiment, the system may carry out at least one of the following: identify a form or ID, associate a social media account, associate a service account, associate an image from social media, associate a review, associate an external user website, calculate a sharing economy value or rental value, associate an affiliate network or affiliate a software for the referral or peer-to-peer renters and/or lenders into the peer-to-peer designer clothing sharing system from external sources, integrate data from another collaborative or sharing economy provider and integrate data from a third party insurance provider.

In this specification, a predetermined closing time may include any time interval or time period which may be assigned by a user or the system. Further, placing a bid may include at least one of buying a product at a fixed price, buying a product at an asking price or buying a product at an accepted offer price.

A fixed price may be entered by a lender or a lender may assign an auction to include at least one of a make an offer, a buy it for a fixed price or end after a predetermined time.

In a further embodiment, the lender may set a fixed price, or a fixed priced for winning bids, or may set a minimum starting value for the bids, or may be able to electronically accept or assess offers from renters or potential renters.

The system may also produce and electronically deliver a customized two-dimensional (2D) or 3D printing file to the lender or borrower. Further, the preferred 2D or 3D printing file may include electronic printer instructions to print the package or label.

In yet another embodiment, the system may record a borrower profile associated with the borrower and a lender profile associated with the lender. Each lender's profile may include a list of designer clothing available to be rented; and a respective time availability information. After a borrower places accepts an asking price to rent at least one piece of designer clothing from the lender profile for a specified available time that matches the respective time availability information. The system may the close the list for the piece of designer clothing from borrowers and awards the rental of the piece of designer clothing to the borrower who accepted the asking price. The borrower may then facilitate a payment to the lender through the use of the system; and the lender arranges transport or pick up of the designer clothing to the borrower.

In at least one embodiment, a sharing portal may mean an online (including mobile or cloud) designer clothing sharing system or portal, displaying or aggregating a combination of rental business and individual owner listings collectively, or displaying or aggregating only multiple rental business' listings, or displaying or aggregating only listings of individual dress owners peer-to-peer or any other combination herein.

FIG. 6 is a block diagram of a computing device included within the computer system described herein. In some embodiments, the present invention may be a computer system, a method, and/or the computing device 222 (of FIG. 6). A basic configuration 232 of a computing device 222 is illustrated in FIG. 6 by those components within the inner dashed line. In the basic configuration 232 of the computing device 222, the computing device 222 includes a processor 234 and a system memory 224. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (μP), a microcontroller (μC), and a digital signal processor (DSP), or any combination thereof. Further, the processor 234 may include one more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, one or more engines, such as the aggregator engine 21, and program data 230. In some embodiments, the aggregator engine 21 may be an application, a software program, a service, or a software platform, as described infra. The system memory 224 may also include a storage engine 228 that may store any information disclosed herein.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 268.

Further, the one or more communication devices 264 may include a network controller 258, which is arranged to facilitate communication with one or more other computing devices 262 over a network communication link via one or more communication ports 260. The one or more other computing devices 262 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in the method steps described herein. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system for use in a rental of designer clothing between lenders and borrowers, the system comprising:
a server;
a first website housed on the Internet, the first website being associated with a first lender and comprising information associated with a first list of designer clothing to be rented;
a second website housed on the Internet, the second website being associated with a second lender and comprising information associated with a second list of designer clothing to be rented;
a computing device associated with a borrower;
a web portal interface; and
an aggregator configured to be operated by software executed on the server, the aggregator being configured to:
record a first profile associated with the first lender, a second profile associated with the second lender, and a third profile associated with the borrower;
data mine the first website and the second website to detect items from the first list of the designer clothing and the second list of the designer clothing;
detect information associated with each piece of clothing from the first list of the designer clothing and the second list of the designer clothing, wherein the information comprises at least an available time frame for rental of each piece of the clothing and an image of each piece of the clothing;
replicate an extract of the first list of the designer clothing and the second list of the designer clothing for display via the web portal interface;
in response to the borrower searching the replicated extract on the web portal interface, receive a desire, from the borrower, to rent a first item of clothing from the first list of the designer clothing for a first time frame;
identify, in real-time, that the first time frame is within the available time frame that the first item from the first list of the designer clothing is available for rent;
notify the borrower of an acceptance from the first lender to rent the first item to the borrower during the first time frame;
receive a payment from the borrower; and
initiate a transmission of at least a portion of the payment to the first lender; and
the first lender being configured to deliver the first item from the first list of the designer clothing directly or as facilitated by the aggregator to the borrower for a start of the first time frame.

2. The system of claim 1, wherein the first lender is a designer clothing rental business, and wherein the second lender is an owner of the second list of designer clothing.

3. The system of claim 1, wherein the aggregator is further configured to:
detect an amendment or an addition of information associated with the first list of the designer clothing and the second list of the designer clothing; and
modify the replicated extract on the web portal interface based on the amendment or the addition.

4. The system of claim 1, wherein the aggregator is further configured to:
transmit a customized two-dimensional (2D) or three-dimensional (3D) printing file to the borrower.

5. The system of claim 1, further comprising:
a system operator being configured to perform an item verification step to determine an authenticity of each piece of clothing from the first list of the designer clothing and the second list of the designer clothing.

6. The system of claim 1, wherein the delivery of the first item from the first list of the designer clothing to the borrower occurs via a drone delivery system.

7. The system of claim 1, wherein the information associated with each piece of clothing from the first list of the designer clothing and the second list of the designer clothing further comprises: a cost, a condition, a description, a color, a size, a video.

8. The system of claim 1, wherein the aggregator is further configured to:
detect an added item of designer clothing to the first list of the designer clothing;
detect the information associated with the added item;
compare the information associated with the added item to preferred information housed in the third profile associated with the borrower;
identify a match between the information associated with the added item and a subset of the preferred information housed in the third profile associated with the borrower; and
automatically alert or message the borrower of the added item.

9. The system of claim 1, wherein the aggregator is further configured to:
calculate a sharing economy value for each item of clothing from the first list of the designer clothing and the second list of the designer clothing.

10. The system of claim 9, wherein the sharing economy value is based on factors selected from the group consisting of: a condition of each item of clothing, historical data associated with each item of clothing, a demand for each item of clothing, a likelihood of future renting of each item of clothing, and a price of a similar item of clothing.

11. The system of claim 10, wherein the historical data is associated with a frequency by which each item of clothing from the first list of the designer clothing and the second list of the designer clothing has been successfully previously rented such that the sharing economy value is greater in response to a higher frequency.

12. The system of claim 10, wherein the aggregator is further configured to:
detect an amendment or an addition of information associated with a given item of clothing from the first list of the designer clothing or the second list of the designer clothing; and
automatically and in real-time re-calculate the sharing economy value for the given item of clothing based on the information.

13. The system of claim 10, wherein the aggregator is further configured to:
automatically and in real-time display the sharing economy value via the web portal interface.

14. A system for transacting a rental of items of designer clothing between lenders and borrowers, the system comprising:
a server;
a first website housed on the Internet, the first website being associated with a first lender and comprising information associated with a first list of designer clothing for rent, wherein the first lender is a rental business;
a second website housed on the Internet, the second website being associated with a second lender and comprising information associated with a second list of designer clothing for rent,
wherein the second lender is a direct owner of the second list of designer clothing, and
wherein the information associated with the first and the second list of the designer clothing comprises at least a time period that each piece of the designer clothing is available for rent and an image associated with each piece of the designer clothing;
a first computing device associated with a first borrower;
a second computing device associated with a second borrower;
a web portal interface; and
an aggregator configured to be operated by software executed on the server, the aggregator being configured to:
data mine the first website and the second website to detect items from the first and the second list of the designer clothing;
detect at least the time period that each piece of the designer clothing is available for rent and the image associated with each piece of the designer clothing from the first and the second list of the designer clothing;
replicate an extract or a version of the extract of the first and the second list of the designer clothing for display on the web portal interface;
set a minimum starting value for a bid on a first item from the first list of the designer clothing;
in response to the first borrower and the second borrower searching the extract replication on the web portal interface,
receive, from the first borrower, a first bid to rent the first item from the first list of the designer clothing for a first time frame; and
receive, from the second borrower, a second bid to rent the first item from the first list of the designer clothing for the first time frame; and
receive, from the first or second borrower, acceptance of an option to subscribe to ongoing bids;
identify, in real-time, that the first time frame is within the time period that the first item from the first list of the designer clothing is available for rent;
close the bidding process temporarily or permanently after an amount of time has lapsed or an event has been triggered;
detect that the second bid is greater than or equal to the first bid;
if the second bid is greater than the first bid, notify the second borrower of a winning bid to rent the first item from the first list of the designer clothing for the first time frame;
if there is only one bid, or if the first bid and the second bid are equal, notify the winning borrower of their successful bid to rent the first item from the first list of the designer clothing for the first time frame; and
receive a first payment from the winning borrower; and
the first lender being configured to deliver the first item from the first list of the designer clothing directly or as facilitated by the aggregator to the winning borrower for a start of the first time frame.

15. The system of claim 14, wherein the aggregator is further configured to:
detect an amendment or an addition of information associated with the first list of the designer clothing and the second list of the designer clothing; and
modify the replicated extract on the web portal interface based on the amendment or the addition.

16. The system of claim 14, further comprising:
a system operator being configured to perform an item verification step to determine an authenticity of each piece of clothing from the first list of the designer clothing and the second list of the designer clothing.

17. The system of claim 14, wherein the aggregator is further configured to:
calculate a sharing economy value for each item of clothing from the first list of the designer clothing and the second list of the designer clothing; and
automatically and in real-time display the sharing economy value via the web portal interface.

18. The system of claim 17,
wherein the sharing economy value is based on factors selected from the group consisting of: a condition of each item of clothing, historical data associated with each item of clothing, a demand for each item of clothing, a likelihood of future renting of each item of clothing, and a price of a similar item of clothing, and
wherein the historical data is associated with a frequency by which each item of clothing from the first list of the designer clothing and the second list of the designer clothing has been successfully previously rented such that the sharing economy value is greater in response to a higher frequency.

19. The system of claim 17, wherein the aggregator is further configured to:
detect an amendment or an addition of information associated with a given item of clothing from the first list of the designer clothing or the second list of the designer clothing; and
automatically and in real-time re-calculate the sharing economy value for the given item of clothing based on the information.

20. The system of claim 14, wherein the aggregator is further configured to:
prompt the first borrower, the second borrower, the first lender, and the second lender to submit a form of suitable identification; and
validate the form of suitable identification to ensure compliance with at least one regulation.
